(19) United States
(12) Patent Application Publication
(10) Pub. No.: US 2020/0326603 A1
(43) Pub. Date: Oct. 15, 2020

(54) APPARATUS FOR OPERATING AN ELECTROACTIVE DEVICE AND A METHOD OF USING THE SAME

(71) Applicant: SAGE ELECTROCHROMICS, INC., Faribault, MN (US)

(72) Inventors: Yigang WANG, Plymouth, MN (US); Anna BROWN, Owatonna, MN (US); Ruth Anne Sarah SCHLITZ, Burnsville, MN (US); Bryan D. GREER, Northfield, MN (US)

(21) Appl. No.: 16/830,179

(22) Filed: Mar. 25, 2020

Related U.S. Application Data
(60) Provisional application No. 62/831,471, filed on Apr. 9, 2019.

(51) Int. Cl. G02F 1/163; G02F 1/155; G02F 1/1524

(52) U.S. Cl. CPC G02F 1/163; G02F 1/1524; G02F 1/155

(57) ABSTRACT

A method of controlling an electroactive device can include operating the electroactive device at an operating parameter for a first period of time, applying a switching voltage having a first magnitude and a first polarity to the electroactive device for a second period of time, and applying a step-wise overshoot voltage having a second magnitude and a second polarity to the electroactive device for a transition period of time. The first magnitude can be greater than the second magnitude, and the first polarity can be the same as the second polarity. The method can also include applying a reverse overshoot voltage having a third magnitude and a third polarity to the electroactive device. The third polarity can be the opposite the second polarity.

### CROSS-REFERENCE TO RELATED APPLICATION(S)

This application claims priority under 35 U.S.C. § 119(e) to U.S. Patent Application No. 62/831,471, entitled “APPARATUS FOR OPERATING A ELECTROACTIVE DEVICE AND A METHOD OF USING THE SAME,” by Yigang WANG et al., filed Apr. 9, 2019, which is assigned to the current assignee hereof and incorporated herein by reference in its entirety.

### FIELD OF THE DISCLOSURE

The present disclosure is directed to apparatuses that operate electroactive devices, and methods of using the same.

### BACKGROUND

A electroactive device can reduce glare and the amount of sunlight entering a room. As an electroactive device switches from a state of low transmission to a state of high transmission or visa versa the change can be noticeable in various areas of the electroactive device. For example, the center of the device may have a higher transmission than the edge of the device as the device is transitioning. The actual visible transmittance may not be sufficiently uniform and can be detected by the naked eye. It may be desired to have a reduced center-to-edge difference or more uniform transition appearance as the same voltage is applied to all areas of the electroactive device. Further improvement in control of electroactive devices is desired.

### BRIEF DESCRIPTION OF THE DRAWINGS

Embodiments are illustrated by way of example and are not limited in the accompanying figures.

FIG. 1 includes an illustration of a cross-sectional view of a portion of glazing including a electroactive device.

FIG. 2 includes an illustration of a top view of the glazing of FIG. 1.

FIG. 3 includes a circuit diagram of an exemplary circuit that can be used to model the behavior of a electroactive device.

FIG. 4 includes a flow chart for a method of operating a electroactive device.

FIG. 5 includes a diagram of a gentle overshoot strategy and transmittance according to one embodiment.

FIG. 6 includes a diagram of gentle overshoot strategy and transmittance, according to another embodiment.

FIG. 7 includes a diagram of gentle overshoot strategies, according to another embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The terms “normal operation” and “normal operating state” refer to conditions under which an electrical component or device is designed to operate. The conditions may be obtained from a data sheet or other information regarding voltages, currents, capacitances, resistances, or other electrical parameters. Thus, normal operation does not include operating an electrical component or device well beyond its design limits.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

A method can be used to control the operation of one or more electroactive devices. The electroactive device can be used within an apparatus. The apparatus can further include a control device that controls the electroactive device. Components within the apparatus may be located near or remotely from the electroactive device.

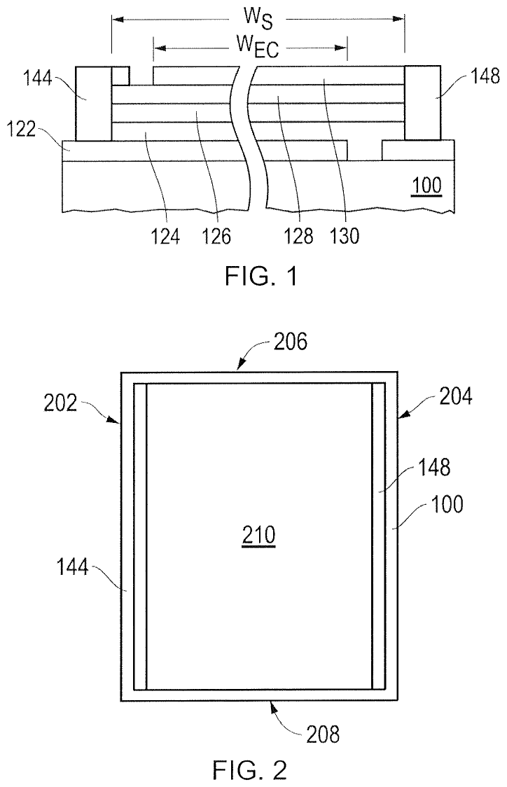

FIG. 1 includes a cross-sectional view of a portion of substrate 100, a stack of layers 122, 124, 126, 128, and 130, and bus bars 144 and 148 overlying the substrate 100. In an embodiment, the substrate 100 can include a glass substrate, a sapphire substrate, an aluminum oxynitride substrate, or a spinel substrate. In another embodiment, the substrate 100 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 100 may or may not be flexible. In a particular embodiment, the substrate 100 can be float glass or a borosilicate glass and have a thickness in a range of 0.5 mm to 4 mm thick. In another particular embodiment, the substrate 100 can include ultra-thin glass that is a mineral glass having a thickness in a range of 50 microns to 300 microns. In a particular embodiment, the substrate 100 may be used for many different electroactive devices being formed and may referred to as a motherboard.

The compositions and thicknesses of the layers are described before describing their formation. Transparent conductive layers 122 and 130 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 122 and 130 can include gold, silver, copper, nickel, aluminum, or any combination thereof. The transparent conductive layers 122 and 130 can have the same or different compositions.

The set of layers further includes an electrochromic stack that includes the layers 124, 126, and 128 that are disposed between the transparent conductive layers 122 and 130. The layers 124 and 128 are electrode layers, wherein one of the layers is an electrochromic layer, and the other of the layers is an ion storage layer (also referred to as a counter electrode layer). The electrochromic layer can include an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 50 nm to 2000 nm. The ion storage layer can include any of the materials listed with respect to the electrochromic layer or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 80 nm to 500 nm. An ion conductive layer 126 (also referred to as an electrolyte layer) is disposed between the electrode layers 124 and 128, and has a thickness in a range of 20 microns to 60 microns. The ion conductive layer 126 allows ions to migrate therethrough and does not allow a significant number of electrons to pass therethrough. The ion conductive layer 126 can include a silicate with or without lithium, aluminum, zirconium, phosphorus, boron; a borate with or without lithium; a tantalum oxide with or without lithium; a lanthanide-based material with or without lithium; another lithium-based ceramic material; or the like. The ion conductive layer 126 is optional and, when present, may be formed by deposition or, after depositing the other layers, reacting portions of two different layers, such as the electrode layers 124 and 128, to form the ion conductive layer 126. After reading this specification, skilled artisans will appreciate that other compositions and thicknesses for the layers 122, 124, 126, 128, and 130 can be used without departing from the scope of the concepts described herein.

The layers 122, 124, 126, 128, and 130 can be formed over the substrate 100 with or without any intervening patterning steps, breaking vacuum, or exposing an intermediate layer to air before all the layers are formed. In an embodiment, the layers 122, 124, 126, 128, and 130 can be serially deposited. The layers 122, 124, 126, 128, and 130 may be formed using physical vapor deposition or chemical vapor deposition. In a particular embodiment, the layers 122, 124, 126, 128, and 130 are sputter deposited.

In the embodiment illustrated in FIG. 1, each of the transparent conductive layers 122 and 130 include portions removed, so that the bus bars 144 and 148 are not electrically connected to each other. Such removed portions are typically 20 nm to 2000 nm wide. In a particular embodiment, the bus bar 144 is electrically connected to the electrode layer 124 via the transparent conductive layer 122, and the bus bar 148 is electrically connected to the electrode layer 148 via the transparent conductive layer 130. The bus bars 144 and 148 include a conductive material. In an embodiment, each of the bus bars 144 and 148 can be formed using a conductive ink, such as a silver frit, that is printed over the transparent conductive layer 122. In another embodiment, one or both of the bus bars 144 and 148 can include a metal-filled polymer. In a particular embodiment (not illustrated), the bus bar 148 is a non-penetrating bus bar that can include the metal-filled polymer that is over the transparent conductive layer 130 and spaced apart from the layers 122, 124, 126, and 128. The viscosity of the precursor for the metal-filled polymer may be sufficiently high enough to keep the precursor from flowing through cracks or other microscopic defects in the underlying layers that might be otherwise problematic for the conductive ink. The lower transparent conductive layer 122 does not need to be patterned in this particular embodiment.

In the embodiment illustrated, the width of the electroactive device W_{EC} is a dimension that corresponds to the lateral distance between the removed portions of the transparent conductive layers 122 and 130. W_{EC} corresponds to one of the planar dimensions of the tintable area of the electroactive device. W_{S} is the width of the stack between the bus bars 144 and 148. The difference in W_{S} and W_{EC} is at most 5 cm, at most 2 cm, or at most 0.9 cm. Thus, most of the width of the stack corresponds to the operational part of the electroactive device that allows for different transmission states. In an embodiment, such operational part is the main body of the electroactive device and can occupy at least 90%, at least 95%, at least 98% or more of the area between the bus bars 144 and 148.

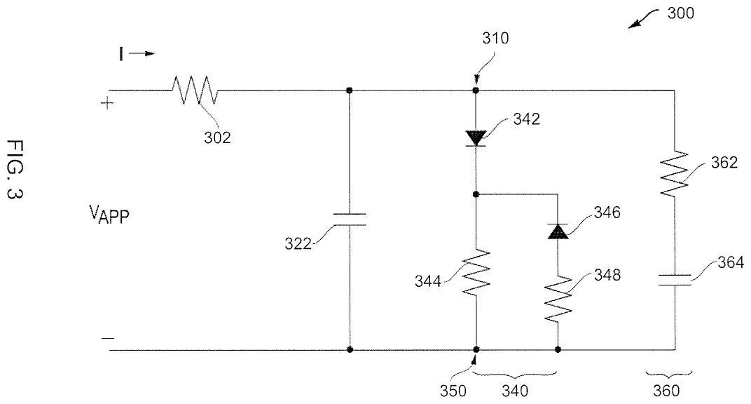

FIG. 2 includes a top view of the substrate 100 and a electroactive device 210 that includes the layers as described with respect to FIG. 1. The bus bar 144 lies along a side 202 of the substrate 100, and the bus bar 148 lies along a side 204 that is opposite the side 202. Each of the bus bars 144 and 148 have lengths that extend a majority of the distance between a side 206 and a side 208 that is opposite the side 206. In a particular embodiment, each of the bus bars 144 and 148 have a length that is at least 75%, at least 90%, or at least 95% of the distance between the sides 206 and 208. The lengths of the bus bars 144 and 148 are substantially parallel to each other. As used herein, substantially parallel is intended to means that the lengths of the bus bars 144 and 148 are within 10 degrees of being parallel to each other. Along the length, each of the bus bars has a substantially uniform cross-sectional area and composition. Thus, in such an embodiment, the bus bars 144 and 148 have a substantially constant resistance per unit length along their respective lengths.

The embodiments described above are merely illustrative. Other designs for electroactive devices, other IGUs, or a combination thereof may be used. Attention is now directed the modeling of the behavior and methods of operation a electroactive device.

FIG. 3 is a schematic diagram of a circuit 300 that can be used to model the behavior of a electroactive device. An external voltage (V_{APP}) is applied to the circuit 300, and a current I flow through the circuit 300. Some voltage is lost due to wires, contacts, and bus bars, as represented by a resistor 302. The interval voltage (V_{INT}) is the voltage between nodes 310 and 350 and represents the voltage across the stack of layers 122, 124, 126, 128, and 130. V_{INT} may depend on location and switching history of the electroactive device.

The circuit 300 includes an electronic portion 340 that represents electrons flowing within the circuit, and an ionic portion 360 that represents ions flowing within the circuit. The current I is equal to the current flowing through the electronic portion 340 and current flowing through the ionic portion 360. Current though the ionic portion 360 is significant during switching operations and is significantly less, possibly even 0, when the non-transmitting device is being held at a constant visible transmittance for an extended time period. Leakage electronic current is the current through the electronic portion 340 when the non-transmitting device is being held at a constant visible transmittance at and after the extended time period.

Other parts of the circuit 300 are described to provide a better understanding of the circuit and how it corresponds to the electroactive device. Capacitor 322 represents the equivalent capacitance between the transparent conductive layers 122 and 130. Diode 342 is used to represent that electronic leakage current is very close to zero in the reverse direction. However, when the electroactive device is in a fully bleached state, reverse electronic leakage current can be as large as forward electronic leakage current. Resistors 344 and 348, and diode 346 closely approximate the electronic leakage current behavior of the electroactive device, as it has a solid-state ion conductive layer. Electronic current increases linearly with voltage up to a threshold voltage, beyond which current increases much more rapidly. The voltage across the diode 346 is typically between 1.5 V and 2.0 V. The resistance of resistors 344 and 348 depend on device dimensions. In an embodiment, the resistance of resistor 344 is at least an order of magnitude greater than the resistance of the resistor 348. The resistances of the resistors 344 and 348 and voltage corresponding to the diode 346 may depend on temperature.

The resistor 362 corresponds to the ionic impedance of the electroactive device. The ionic impedance can be a function of both device visible transmittance and the temperature of the device. The ionic impedance can vary by more than an order of magnitude over the operating temperature range (−40 C to 100 C) of the electroactive device. The electroactive device can act similar to a battery, and thus, capacitor 364 represents the effect of the battery. The voltage between the electrodes of the capacitor 364 can be in a range of −1.0 V to +2.0V. In A particular embodiment, voltage differences between the electrodes of the capacitor 346 can be in a range of 0.0 V (for fully bleached) and +1.5 V (for fully tinted).

The inventors have discovered that more accurate characterization, including derived parameters can be achieved when a gentle overshoot strategy is employed with the electroactive device. The electroactive device is put into a gentle overshoot mode where a step-wise overshoot voltage is applied followed by a reverse overshoot voltage to the electroactive device. The overshoot voltage is a voltage that causes the electrochromic device to change from a first transmittance state to a second transmittance state, ie going from a low transmittance state to a high transmittance state or from a high transmittance state to a low transmittance state; for example, going from a state of 60% transmission to a 6% transmission. In the example going from +4V to −3V is going in the tinting direction while going from −3V to +4V is going in the clearing direction. The reverse overshoot voltage is a voltage going in the opposite direction from the overshoot voltage. If, for example, the overshoot voltage is in the tinting direction, the reverse overshoot is in the clearing direction.

The gentle overshoot mode allows for better uniformity in transmission across the electroactive device. If the electroactive device is to go from a higher visible transmittance to a lower visible transmittance, the gentle overshoot voltage is a tinting voltage. If the electroactive device is to go from a lower visible transmittance to a higher visible transmittance, the gentle overshoot current is a bleaching voltage. After the overshoot voltage and reverse overshoot voltage, the voltage is set to the value corresponding to a visible transmittance of 6%. While the new technique may hold the electroactive device at an applied voltage corresponding to the overshoot voltage for a longer period of time, the transmission of the electroactive device at the edge and in the center is more uniform, i.e. a more uniform center-to-edge transition.

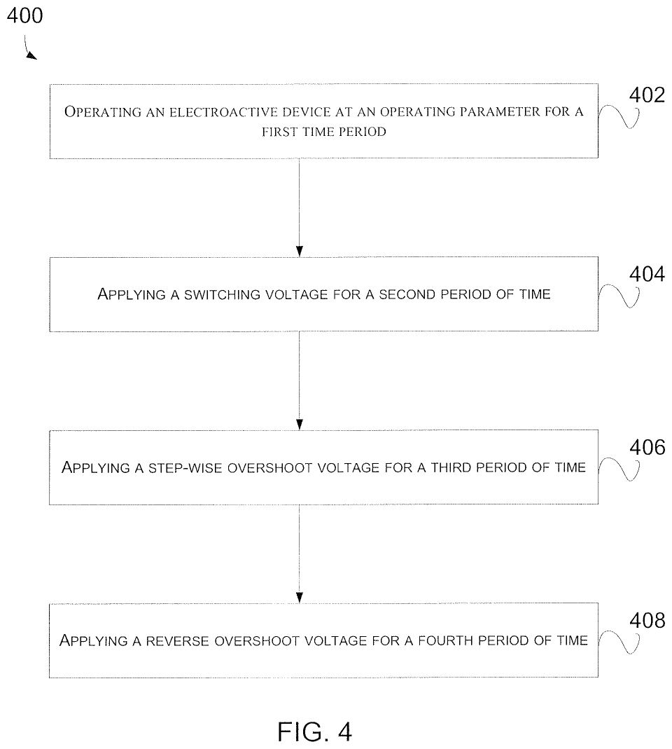

A method can be used to operate a single electroactive devices as well as a plurality of electroactive devices. In an embodiment, the method for the plurality of electroactive devices can leverage the method corresponding to FIG. 4; however, the method corresponding to FIG. 4 that is directed to a electroactive device is not required when operation the plurality of the electroactive devices. The method for the plurality of electroactive device can be particularly useful for a set of windows including electroactive devices and to a single window that includes a plurality of zones each including an independently controlled electroactive device. Although electroactive devices can be designed to have the same composition and thickness of layers and have the same cuts and bus bars, differences still occur due to manufacturing variation, even with the best controlled processes. The difference can become vary apparent when operating as a set of electroactive devices that are located close to one another.

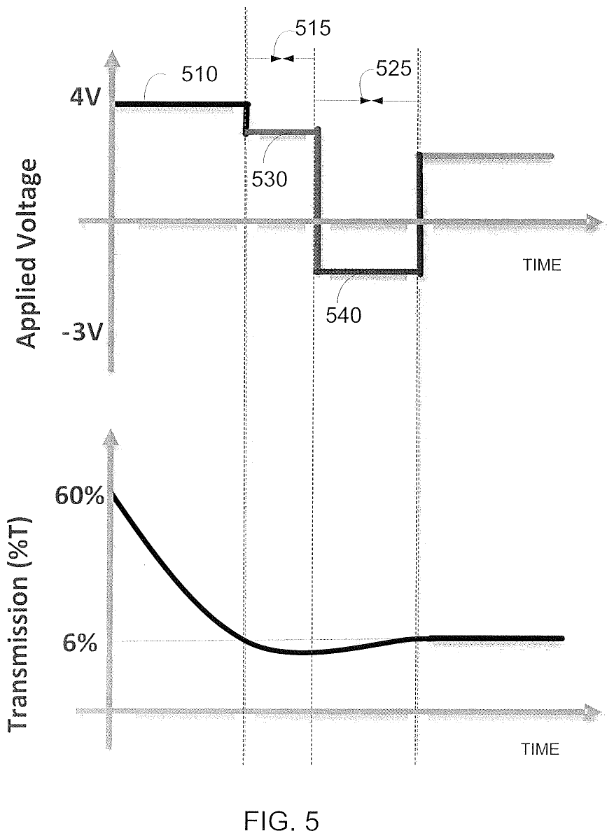

FIG. 4 includes a flow chart for a method 400 of operating a electroactive device. FIGS. 1 and 5 are referenced during portions of the flow chart to aid in understanding the method. FIG. 5 shows the voltages applied to and transmission states of an electroactive device as a function of time, according to one embodiment. The method 400 includes operating the electroactive device at an operating parameter for a first period of time, at operation 402 in FIG. 4. The operating parameter can be V_{APP}, a current, or other suitable parameter used in operating the electroactive device.

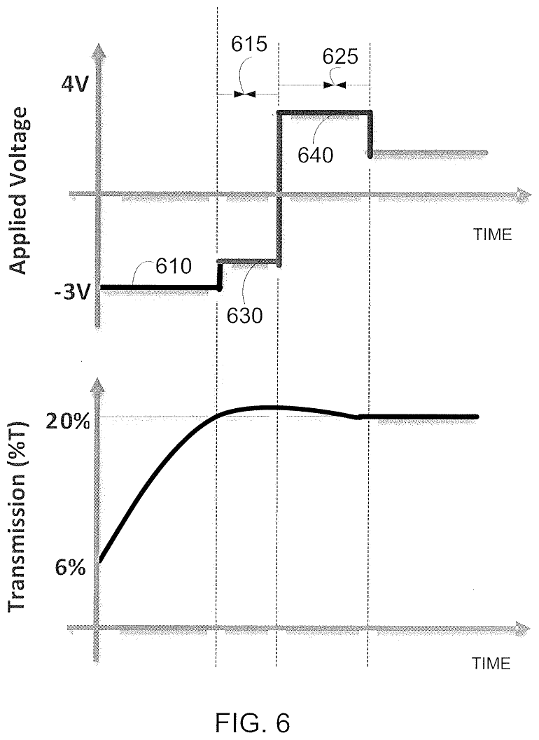

In one embodiment, the operating parameter can be set at a active positive voltage for the electroactive device. In another embodiment, the operating parameter can be set a a active negative voltage for the electroactive device. In one embodiment, the operating parameter can be at full bleach or clear for the electroactive device. In another embodiment, the operating parameter can be at full tint for the electroactive device, as seen in FIG. 6. The electroactive device can have a transition voltage. The transition voltage is the change in voltage requirement necessary to switch the electroactive device from a first state, such as a tinted state, to a second state, such as a bleached state. For example, in FIG. 5, the transition voltage is 7V, equaling the difference in voltage between the active tint voltage 4V and the active clear voltage −3V. If the electroactive device is to go from a higher visible transmittance, such as 60% transmittance, to a lower visible transmittance, such as 6% transmittance, the direction the electrochromic device can be a tinting direction. If the electroactive device is to go from a lower visible transmittance, such as 6% transmittance, to a higher visible transmittance, such as 20% transmittance, the electrochromic device can be a clearing direction. The inventors have discovered that applying a gentle overshoot with a reverse overshoot strategy to transition the electrochromic device from a first state to a second state produces a more uniform transition appearance between the edge of the device and the center of the device.

At operation 404, a switching voltage 510 is applied to the electroactive device for a second period of time. In one embodiment, the switching voltage 510 can be an active tinting voltage, as seen in FIG. 5. In one embodiment, the switching voltage 510 can have a first magnitude and a first polarity. In one embodiment, the switching voltage is the voltage necessary to achieve 6% transmission in the electroactive device. As the transmittance of the electroactive device decreases, the electroactive device can go into an overshoot period where the transmission of the electroactive device is below 6%. Once the transmittance of the electroactive device is less than 6%, a step-wise overshoot voltage 530 can be applied.

At operation 404, a step-wise overshoot voltage 530 is applied for a third period of time 515. In one embodiment, the overshoot voltage can be between 0V and the switching voltage 510. In one embodiment, the step-wise overshoot voltage can be constant, as seen in FIG. 5. In another embodiment, the step-wise overshoot voltage can be varied. In yet another embodiment, the step-wise overshoot voltage can be constantly changing over time, such as seen in a nonlinear curve, piece-wise curve, or linear curve. In one embodiment, the overshoot voltage can be greater than or equal to 0V and less than 4V. In one embodiment, the step-wise overshoot voltage can include a first step overshoot voltage 530 having a second magnitude and a second polarity. In one embodiment, the first polarity is the same as the second polarity. In one embodiment, the first magnitude is greater than the second magnitude. In one embodiment, the step-wise overshoot voltage can include at least two overshoot voltages. In another embodiment, the step-wise overshoot voltage can include at least three overshoot voltages. In another embodiment, the step-wise overshoot voltage can include at least four overshoot voltages. In yet another embodiment, the step-wise overshoot voltage can include at least five overshoot voltages. In one embodiment, the third period of time 515 is less than a fourth period of time 525. In another embodiment, the third period of time 515 is less than the second period of time. In another embodiment, the third period of time 515 can include a first step transition period of time and a second step transition period of time. The third period of time 515 period of time can be the time between applying the first step overshoot voltage 530 and applying a reverse overshoot voltage 540.

After applying the step-wise overshoot voltage, a reverse overshoot voltage 540 having a third magnitude and a third polarity can be applied to the electroactive device, at operation 408. In one embodiment, the reverse overshoot voltage can be constant. In another embodiment, the reverse overshoot voltage can be varied. In yet another embodiment, the reverse overshoot voltage can be constantly changing over time, such as seen in a nonlinear curve, piece-wise curve, or linear curve. In one embodiment, the third magnitude can be less than the second magnitude. In one embodiment, the third magnitude can be less than the first magnitude. In on embodiment, the third magnitude can be greater than the second magnitude. In one embodiment, the third polarity is the same as the second polarity. In one embodiment, the third polarity is opposite the second polarity. In the fourth time period 525, the electrochromic device is going in the opposite direction as the third time period 515. In one embodiment, in the fourth time period the electrochromic device can be going in the clearing direction while in the third time period 515, the electrochromic device can be going in the tinting direction. In other words, in the fourth time period 525, the electrochromic device can be going from a state of lower transmittance, such as less than 4% transmittance, to a state of higher transmittance, such as greater than 4% transmittance but less than 6% transmittance. In the embodiment of FIG. 5, the second magnitude 530 can be less than the first magnitude 510 and the third magnitude 540 can be smaller than the second magnitude 530. In another embodiment, the second magnitude 530 can be smaller than the first magnitude 510 and the third magnitude 540 can be larger than the second magnitude 530.

After applying the reverse overshoot voltage to the electroactive device, a holding voltage having a fourth magnitude and fourth polarity can be applied to the electrochromic device and held for a fifth period of time. In one embodiment, the fifth period of time is greater than the fourth period of time 525. In another embodiment, the fifth period of time is greater than the third period of time 515. In one embodiment, the first magnitude is greater than the second magnitude, the second magnitude is less than the third magnitude, and the fourth magnitude is less than the third magnitude. In another embodiment, the first magnitude is greater than the second magnitude, the second magnitude is less than the third magnitude, and the fourth magnitude is less than the third magnitude. In yet another embodiment, the first magnitude is greater than the second magnitude, the second magnitude is equal to the third magnitude, and the fourth magnitude is greater than the third magnitude. In yet another embodiment, the first magnitude is greater than the second magnitude, the second magnitude is less than the third magnitude, and the fourth magnitude is greater than the third magnitude. In one embodiment, the first polarity can be the same as the second polarity, the third polarity can be the opposite of the second polarity, and the fourth polarity can be the opposite of the third polarity. In another embodiment, the first polarity can be the same as the second polarity, the third polarity can be the same as the second polarity, and the fourth polarity can be the same as the third polarity.

FIG. 6 includes a diagram of gentle overshoot strategies, according to another embodiment. The device may be in a different operating parameter than that seen in FIG. 5. FIG. 6 shows the operating parameter can be at full tint for the electroactive device and the method of going in the clearing direction or in a state from low transmission (% T) to a state of high transmission (% T). A switching voltage 610 is applied to the electroactive device for a second period of time. In one embodiment, the switching voltage can be an active clearing voltage, as seen in FIG. 6. In one embodiment, the switching voltage can have a first magnitude and a first polarity. In one embodiment, the switching voltage is the voltage necessary to achieve 20% transmission in the electroactive device, when the device is going from a first state to a second state and the first state has a lower transmittance than the second state. As the transmittance of the electroactive device increases, the electroactive device can go into an overshoot period where the transmission of the electroactive device is above 20%. Once the transmittance of the electroactive device is above 20%, a step-wise overshoot voltage 630 is applied.

At operation 404, a step-wise overshoot voltage 630 is applied for a third period of time 615. In one embodiment, the overshoot voltage can be between 0V and the active clear voltage. In one embodiment, the step-wise overshoot voltage can be constant, as seen in FIG. 5. In another embodiment, the step-wise overshoot voltage can be varied. In one embodiment, the overshoot voltage can be greater than or equal to 0V and less than −3V. In one embodiment, the step-wise overshoot voltage can include a first step overshoot voltage 630 having a second magnitude and a second polarity. In one embodiment, the first polarity is the same as the second polarity. In one embodiment, the first magnitude is greater than the second magnitude. In one embodiment, the step-wise overshoot voltage can include at least two overshoot voltages. In another embodiment, the step-wise overshoot voltage can include at least three overshoot voltages. In another embodiment, the step-wise overshoot voltage can include at least four overshoot voltages. In yet another embodiment, the step-wise overshoot voltage can include at least five overshoot voltages. In one embodiment, the third period of time 615 is less than a fourth period of time 625. In another embodiment, the third period of time 615 is less than the second period of time. In another embodiment, the third period of time 615 can include a first step transition period of time and a second step transition period of time. The third period of time 615 can be the time between applying the first step overshoot voltage 630 and applying a reverse overshoot voltage 640.

After applying the step-wise overshoot voltage, a reverse overshoot voltage 640 having a third magnitude and a third polarity can be applied to the electroactive device, at operation 408. In one embodiment, the third magnitude can be less than the second magnitude. In one embodiment, the third magnitude can be less than the first magnitude. In on embodiment, the third magnitude can be greater than the second magnitude. In one embodiment, the third polarity is the same as the second polarity. In one embodiment, the third polarity is opposite the second polarity. In the fourth time period 625, the electrochromic device is going in the opposite direction as the third time period 615. In one embodiment, in the fourth time period 625 the electrochromic device can be going in the tinting direction while in the third time period 615, the electrochromic device can be going in the clearing direction. In other words, in the fourth time period 625, the electrochromic device can be going from a state of higher transmittance, such as greater than 20% transmittance, to a state of lower transmittance, such as about 20% transmittance. In the embodiment of FIG. 6, the second magnitude 630 can be less than the first magnitude 610 and the third magnitude 640 can be larger than the second magnitude 630. In another embodiment, the second magnitude 630 can be smaller than the first magnitude 610 and the third magnitude 640 can be smaller than the second magnitude 630.

After applying the reverse overshoot voltage to the electroactive device, a holding voltage having a fourth magnitude and fourth polarity can be applied to the electrochromic device and held for a fifth period of time. In one embodiment, the fifth period of time is greater than the fourth period of time 625. In another embodiment, the fifth period of time is greater than the third period of time 615. In one embodiment, the first magnitude is greater than the second magnitude, the second magnitude is less than the third magnitude, and the fourth magnitude is less than the third magnitude. In another embodiment, the first magnitude is greater than the second magnitude, the second magnitude is less than the third magnitude, and the fourth magnitude is less than the third magnitude. In yet another embodiment, the first magnitude is greater than the second magnitude, the second magnitude is equal to the third magnitude, and the fourth magnitude is greater than the third magnitude. In yet another embodiment, the first magnitude is greater than the second magnitude, the second magnitude is less than the third magnitude, and the fourth magnitude is greater than the third magnitude. In one embodiment, the first polarity can be the same as the second polarity, the third polarity can be the opposite of the second polarity, and the fourth polarity can be the opposite of the third polarity. In another embodiment, the first polarity can be the same as the second polarity, the third polarity can be the same as the second polarity, and the fourth polarity can be the same as the third polarity.

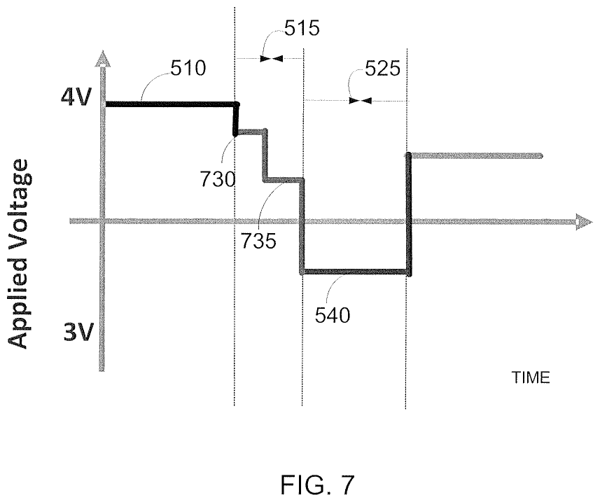

FIG. 7 includes a diagram of gentle overshoot strategies, according to another embodiment. In one embodiment a step-wise overshoot voltage can include a first step overshoot voltage 730 having a first magnitude and a first polarity, a second step overshoot voltage 735 having a second magnitude and a second polarity. In one embodiment, the first polarity of the first step overshoot voltage can be the same as the second polarity of the second step overshoot voltage. In another embodiment a step-wise overshoot voltage can include a first step overshoot voltage having a first magnitude and a first polarity, a second step overshoot voltage having a second magnitude and a second polarity, a third step overshoot voltage having a third magnitude and a third polarity, a fourth overshoot voltage having a fourth magnitude and a fourth polarity, and a fifth overshoot voltage having a fifth magnitude and a fifth polarity. In one embodiment, the magnitudes of the first voltage, the second voltage, the third voltage, the fourth voltage, and the fifth voltage can be different from one another. In another embodiment, the magnitudes of the first voltage, the second voltage, the third voltage, the fourth voltage, and the fifth voltage can be the same as at least one other voltage. In one embodiment, the second magnitude can be less than the first magnitude. In one embodiment, the third magnitude can be the same as the second magnitude. In another embodiment, the fourth magnitude can be the same as the second magnitude. In another embodiment, the fifth magnitude can be less than the second magnitude. In an alternative embodiment, the second magnitude can be greater than the first magnitude. In another embodiment, the second magnitude can be less than the first magnitude, the third magnitude can be less than the second magnitude, the fourth magnitude can be less than the third magnitude, and the fifth magnitude can be about the same as the fourth magnitude.

In one embodiment, the first polarity can be the same as the second polarity, the third polarity can be the same as the fifth polarity, the fourth polarity can be the same as the second polarity, and the third polarity can be the same as the first polarity. In one embodiment, the first polarity can be opposite the polarity of the switching voltage.

The electroactive devices have been described with respect to voltages being applied to such devices. In another embodiment, a device may be controlled by applying a current, rather than applying a voltage. The concepts are described above can be extended to devices that are controlled by an applied current.

Embodiments as described herein allow for better control of electroactive devices. Characterization data for an electroactive device can be obtained during normal operation of such electroactive device. The characterization data can include a characterization parameter that is updated as the electroactive device is normally used. Thus, the control of the electroactive device improves as it can reflect changes in the electroactive device as it is used and ages.

In other embodiments, electroactive devices can be operated in a manner that is better tailored to the electroactive devices. Different electroactive devices can operate differently, even if such electroactive devices have the same nominal areal size, composition and thickness of layers, and are produced during the same production lot. No two electroactive devices are perfectly identical, and therefore, do not have exactly the same visible transmittances when operated at the same operating parameter. Embodiments as described herein can allow operating parameters to be tailored to a subset or even electroactive devices individually to account for differences between the electroactive devices. Thus, more uniformity in visible transmittance between different electroactive devices along a wall or skylight can now be realized. If different transmittances are desired, the methods as described herein can provide actual visible transmittances for different electroactive devices that are closer to the desired visible transmittances when different desired visible transmittances are to be present.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

### Embodiment 1

A method of controlling an electroactive device can include operating the electroactive device at an operating parameter for a first period of time, applying a switching voltage having a first magnitude and a first polarity to the electroactive device for a second period of time, and applying a step-wise overshoot voltage having a second magnitude and a second polarity to the electroactive device for a transition period of time. The first magnitude can be greater than the second magnitude, and the first polarity can be the same as the second polarity. The method can also include applying a reverse overshoot voltage having a third magnitude and a third polarity to the electroactive device. The third polarity can be the opposite the second polarity.

### Embodiment 2

The method of embodiment 1, where the electroactive device can include a transition voltage, the transition voltage can be the voltage difference between an active tinting voltage and an active clear voltage for the electroactive device.

### Embodiment 3

The method of embodiment 2, where the first magnitude can be less than the transition voltage.

### Embodiment 4

The method of embodiment 1, where the third magnitude can be less than the second magnitude.

### Embodiment 5

The method of embodiment 1, where the third magnitude can be greater than the second magnitude.

### Embodiment 6

A method of controlling an electroactive device can include applying a switching voltage having a first magnitude and a first polarity for a first period of time, and applying a step-wise overshoot voltage for a second period of time. Applying the step-wise overshoot voltage can include applying a first step overshoot voltage having a second magnitude and a second polarity, where the first magnitude can be greater than the second magnitude and where the first polarity can be the same as the second polarity, and applying a second step overshoot voltage having a third magnitude and a third polarity. The method can also include applying a reverse overshoot voltage having a fourth magnitude and a fourth polarity to the electroactive device, where the fourth polarity can be the opposite of the first polarity.

### Embodiment 7

The method of embodiment 6, can further include holding the first step overshoot voltage for a first overshoot period of time.

### Embodiment 8

The method of embodiment 6, can further include holding the second step overshoot voltage for a second overshoot period of time.

### Embodiment 9

The method of embodiment 6, where the second magnitude can be greater than the third magnitude.

### Embodiment 10

The method of embodiment 6, where the second magnitude can be less than the third magnitude.

### Embodiment 11

The method of embodiment 6, where the fourth magnitude can be less than the third magnitude.

### Embodiment 12

The method of embodiment 6, where the fourth magnitude can be greater than the third magnitude.

### Embodiment 13

The method of embodiment 6, can further include holding the reverse overshoot voltage for a third period of time.

### Embodiment 14

The method of any of embodiments 1 or 6, where the first magnitude can be at least 55% of the transition voltage and at most 60% of the transition voltage.

### Embodiment 15

The method of any of embodiments 1 or 6, where the second magnitude can be at least at least 10% of the transition voltage and at most 50% of the transition voltage.

### Embodiment 16

The method of any of embodiments 1 or 6, where the third magnitude can be at least at least 5% of the transition voltage and at most 40% of the transition voltage.

### Embodiment 17

A system, can include an electroactive device, and a control system configured to: operate the electroactive device at an operating parameter for a first period of time, apply a switching voltage having a first magnitude and a first polarity to the electroactive device for a second period of time, apply a step-wise overshoot voltage having a second magnitude and a second polarity to the electroactive device for a transition period of time, where the first magnitude can be greater than the second magnitude, and where the first polarity can be the same as the second polarity, and apply a reverse overshoot voltage having a third magnitude and a third polarity to the electroactive device, where the third polarity can be opposite the second polarity.

### Embodiment 18

The method or device of any of embodiments 1, 6, or 17, where the electroactive device can be an electrochromic device.

### Embodiment 19

The method or device of embodiment 18, where the electrochromic device can include: a first transparent conductive layer, a second transparent conductive layer, an anodic electrochemical layer between the first transparent conductive layer and the second transparent conductive layer and a cathodic electrochemical layer between the first transparent conductive layer and the second transparent conductive layer.

### Embodiment 20

The method or device of any of embodiments 1, 6, or 17, where the step-wise overshoot voltage can be applied to bus bars of the electroactive device.

### Embodiment 21

The method or device of any of embodiments 1, 6, or 17, where the step-wise overshoot voltage can be applied to transition the electroactive device from a starting optical state to an ending optical state.

### Embodiment 22

The method or device of any of embodiments 1, 6, or 17, where a sum of the magnitude of the switching voltage and the magnitude of the step-wise overshoot voltage can be less than or equal to the magnitude of the transition voltage.

### Embodiment 23

The method or device of any of embodiments 1, 6, or 17, where each step of the step-wise overshoot voltage can have a magnitude of no greater than 6, such as 5, or no greater than 4.

### Embodiment 24

The method of embodiment 6, can further include applying a third step overshoot voltage having a sixth magnitude and a sixth polarity.

### Embodiment 25

The method of embodiment 24, where the fifth polarity can be the same as the first polarity.

### Embodiment 26

The method of embodiment 6, can further include applying a hold voltage with a fifth magnitude and a fifth polarity for holding the end optical state.

### Embodiment 27

The method of embodiment 26, where the reverse overshoot voltage can be closer to the hold voltage than the step-wise overshoot voltage.

### Embodiment 28

The method of embodiment 26, where the fifth polarity can be opposite the fourth polarity.

### Embodiment 29

The method of embodiment 26, where the fifth polarity can be the same as the fourth polarity.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of controlling an electroactive device, comprising:
operating the electroactive device at an operating parameter for a first period of time;
applying a switching voltage having a first magnitude and a first polarity to the electroactive device for a second period of time;
applying a step-wise overshoot voltage having a second magnitude and a second polarity to the electroactive device for a transition period of time, wherein the first magnitude is greater than the second magnitude, and wherein the first polarity is the same as the second polarity; and
applying a reverse overshoot voltage having a third magnitude and a third polarity to the electroactive device, wherein the third polarity is opposite the second polarity.

2. The method of claim 1, wherein the electroactive device comprises a transition voltage, the transition voltage is the voltage difference between an active tinting voltage and an active clear voltage for the electroactive device.

3. The method of claim 2, wherein the first magnitude is less than the transition voltage.

4. The method of claim 1, wherein the third magnitude is less than the second magnitude.

5. The method of claim 1, wherein the third magnitude is greater than the second magnitude.

6. A method of controlling an electroactive device, comprising:
applying a switching voltage having a first magnitude and a first polarity for a first period of time;
applying a step-wise overshoot voltage for a second period of time, wherein applying the step-wise overshoot voltage comprises:
applying a first step overshoot voltage having a second magnitude and a second polarity, wherein the first magnitude is greater than the second magnitude and wherein the first polarity is the same as the second polarity; and
applying a second step overshoot voltage having a third magnitude and a third polarity; and
applying a reverse overshoot voltage having a fourth magnitude and a fourth polarity to the electroactive device.

7. The method of claim 6, further comprising holding the first step overshoot voltage for a first overshoot period of time.

8. The method of claim 6, further comprising holding the second step overshoot voltage for a second overshoot period of time.

9. The method of claim 6, wherein the second magnitude is greater than the third magnitude.

10. The method of claim 6, wherein the second magnitude is less than the third magnitude.

11. The method of claim 6, wherein the fourth magnitude is less than the third magnitude.

12. The method of claim 6, wherein the fourth magnitude is greater than the third magnitude.

13. The method of claim 6, further comprising holding the reverse overshoot voltage for a third period of time.

14. The method of claim 6, wherein the first magnitude is at least 55% of the transition voltage and at most 60% of the transition voltage.

15. The method of claim 6, wherein the second magnitude is at least at least 10% of the transition voltage and at most 50% of the transition voltage.

16. The method of claim 6, wherein the third magnitude is at least at least 5% of the transition voltage and at most 40% of the transition voltage.

17. A system, comprising:
a electroactive device; and
a control system configured to:
operate the electroactive device at an operating parameter for a first period of time;
apply a switching voltage having a first magnitude and a first polarity to the electroactive device for a second period of time;
apply a step-wise overshoot voltage having a second magnitude and a second polarity to the electroactive device for a transition period of time, wherein the first magnitude is greater than the second magnitude, and wherein the first polarity is the same as the second polarity; and
apply a reverse overshoot voltage having a third magnitude and a third polarity to the electroactive device, wherein the third polarity is opposite the second polarity.

18. The system of claim 17, wherein the electroactive device comprises:
a first transparent conductive layer;
a second transparent conductive layer;
an anodic electrochemical layer between the first transparent conductive layer and the second transparent conductive layer; and
a cathodic electrochemical layer between the first transparent conductive layer and the second transparent conductive layer.

19. The system of claim 17, wherein each step of the step-wise overshoot voltage has a magnitude of no greater than 6.

20. The system of claim 17, wherein a sum of the magnitude of the switching voltage and the magnitude of the step-wise overshoot voltage is less than or equal to the magnitude of the transition voltage.
